(19) United States
(12) Patent Application Publication
(10) Pub. No.: US 2002/0048173 A1
(43) Pub. Date: Apr. 25, 2002

(54) Retractable emergency indicator

(76) Inventor: Richard Schmucker, Perry, GA (US)

Correspondence Address: RICHARD F. JAWORSKI, Cooper & Dunham LLP, 1185 Avenue of the Americas, New York, NY, 10036, US

(21) Appl. No.: 09/896,654

(22) Filed: Jun. 29, 2001

Related U.S. Application Data
(60) Provisional application No. 60/215,566, filed on Jun. 30, 2000.

(51) Int. Cl. B60Q 1/00

(52) U.S. Cl. 362/487; 362/493

(57) ABSTRACT

A light bar assembly retractably mounted within a roof of a vehicle for extending from an opening in the roof of the vehicle includes a roof cover assembly, moveable between a first retracted position and a second extended position covering the hole in the roof of the vehicle, a light bar assembly moveable between a first lowered position and a second raised position extending from the hole in the roof of the vehicle and a control mechanism for selectively controlling the roof assembly and the retractable light bar assembly between there respected first and second positions.

### REFERENCE TO RELATED APPLICATION

This present application claims the benefit of provisional Application Serial No. 60/215,566 filed on Jun. 30, 2000, which is hereby incorporated herein by reference.

### BACKGROUND OF THE DISCLOSURE

1. Field of the Disclosure

The present application relates generally to emergency light systems and, more specifically, to a retractable emergency lighting system for use in connection with emergency vehicles.

2. Description of the Related Art

Vehicles used by law enforcement agencies, fire departments, emergency medical agencies, etc. (referred to herein collectively as emergency vehicles) have traditionally been equipped with one or more flashing lights or light arrays on their roofs. The lights have evolved into what is today commonly referred to as a light bar.

Law enforcement agencies and other agencies across the country have been studying the pros and cons of vehicles without light bars mounted on the roofs. Such vehicles are typically known as slick-top cruisers. Due to the wind resistance of a full size light bar, slick-top vehicles have been considered because of the considerable amount of gasoline saved by their use. In addition, in traffic, slick-top cruisers blend in with civilian vehicles allowing a distinct advantage when tailing and for speeder interception. For unmarked and slick-top vehicles, law enforcement agencies typically mount warning or emergency lights in at least one of the back window, tail lights, grille and the dash.

A major drawback to providing the warning or emergency lights other than on the roof of the vehicle, is safety. For example, making a traffic stop or working an accident scene, a police vehicle without the lights on the roof can be dangerous when compared with vehicles having the lights mounted on the roof. Lights on the roof can be seen from far greater distances than lights provided on other portions of the vehicle. In addition, glare from the sun often washes out the effectiveness of lights provided in the rear window of a vehicle. In addition, if a vehicle stops behind a slick-top vehicle, the emergency lights of the slick-top vehicle can be blocked, thus rendering them ineffective for their intended purpose. In addition, police and other emergency vehicles are sometimes parked in questionable areas where roof mounted lighting systems can be easily damaged and/or stolen. Another concern is for the rise in the number of incidents in which civilian vehicles have been stopped by those posing as law enforcement, using vehicles equipped with flashing lights hidden in the grille, for example. It is virtually impossible for the party being stopped and authorized law enforcement personnel to know whether the vehicle with the hidden flashing lights is an authorized law enforcement vehicle. For these and other reasons, some governing bodies have even enacted legislation requiring emergency lighting to be plainly visible on the roof of the vehicle when making a stop, for example.

### SUMMARY OF THE DISCLOSURE

The present disclosure relates to a light bar assembly retractably mounted within a roof of a vehicle for extending from an opening in the roof of the vehicle, comprising a roof cover assembly, moveable between a first position and a second position covering the opening in the roof of the vehicle. A light bar assembly is moveable between a first position and a second position extending from the opening in the roof of the vehicle and a control mechanism selectively controls the roof assembly and the retractable light bar assemblies between their respective first and second positions.

The control mechanism may comprise pistons for moving the roof assembly and retractable light bar assembly between their respective first and second positions. The pistons may comprise at least one of pneumatic, hydraulic and mechanical pistons. The light bar assembly may further comprise a biasing system for biasing the light bar assembly toward an extended position. The biasing system may comprise a spring assembly. The light bar assembly may comprise a light assembly base for sealing the opening in the room of the vehicle when the light bar assembly is in at least one of the first and second positions.

According to another aspect, a light bar assembly is retractably mounted within a roof of a vehicle for extending from an opening in the roof of the vehicle and includes a light bar assembly moveable between a first position and a second position extending from the opening in the roof of the vehicle, and a roof cover, mounted to a portion of the light bar assembly, for sealing the opening in the roof when the light bar assembly is in at least one of the first and second positions. A control mechanism is provided for selectively controlling the roof assembly and the retractable light bar assembly between their respective first and second positions.

According to another aspect, a light bar assembly is mounted within a roof of a vehicle for extending from an opening in the roof of the vehicle. The assembly includes a rotatable roof assembly, pivotally mounted in the opening in the roof of the vehicle and a light bar assembly, mounted to at least one surface of the rotatable roof assembly. A control mechanism is provided for selectively rotating the rotatable roof assembly between a first position in which the light bar assembly is visible on the roof of the vehicle and a second position, in which the light bar assembly is not visible on the roof of the vehicle.

The light bar assembly may further comprise a gasket assembly provided around at least a portion of a periphery of the opening in the roof of the vehicle, wherein the rotatable roof assembly forms a sealed enclosure with the gasket assembly, when the rotatable roof assembly is in the first and second positions.

### BRIEF DESCRIPTION OF THE DRAWINGS

A more complete appreciation of the present embodiments and many of the attendant advantages thereof will be readily obtained as the same becomes better understood by reference to the following detailed description when considered in connection with the accompanying drawings, wherein:

FIG. 1 depicts a retractable light bar extending from the roof of an emergency vehicle;

FIG. 2 depicts an emergency vehicle in which the retractable light bar has been retracted;

FIGS. 3A, 3B are views of a first embodiment of a mechanism used to control movement of the retractable light bar, as seen from the rear passenger side door of the vehicle;

FIGS. 4A, 4B are views of the first embodiment of the mechanism used to control movement of the retractable light bar, as seen from the front driver side door of the vehicle (FIG. 4A) and from the rear driver side door of the vehicle (FIG. 4B);

FIGS. 5A, 5B are side views of a retractable light bar including a roof cover mounted thereon according to another embodiment, showing the light bar in the raised and retracted positions, respectively, while

FIG. 5C is a front view of the raised light bar;

FIG. 6 is a block diagram of a control system used for controlling the retractable light bar system;

FIG. 7 is a front view of a second embodiment of a mechanism used to control movement of the retractable light bar;

FIG. 8 is a side view taken along lines 8-8 of FIG. 7 of the mechanism used to control movement of the retractable light bar;

FIG. 9 is a view of the interior of the vehicle showing the sealing enclosure; and

FIGS. 10, 10B depict a light assembly unit according to an embodiment.

### DETAILED DESCRIPTION OF THE PREFERRED EMBODIMENTS

In describing preferred embodiments illustrated in the drawings, specific terminology is employed for sake of clarity. However, the present disclosure is not intended to be limited to the specific terminology so selected and it is to be understood that each specific element includes all technical equivalents which operate in a similar manner.

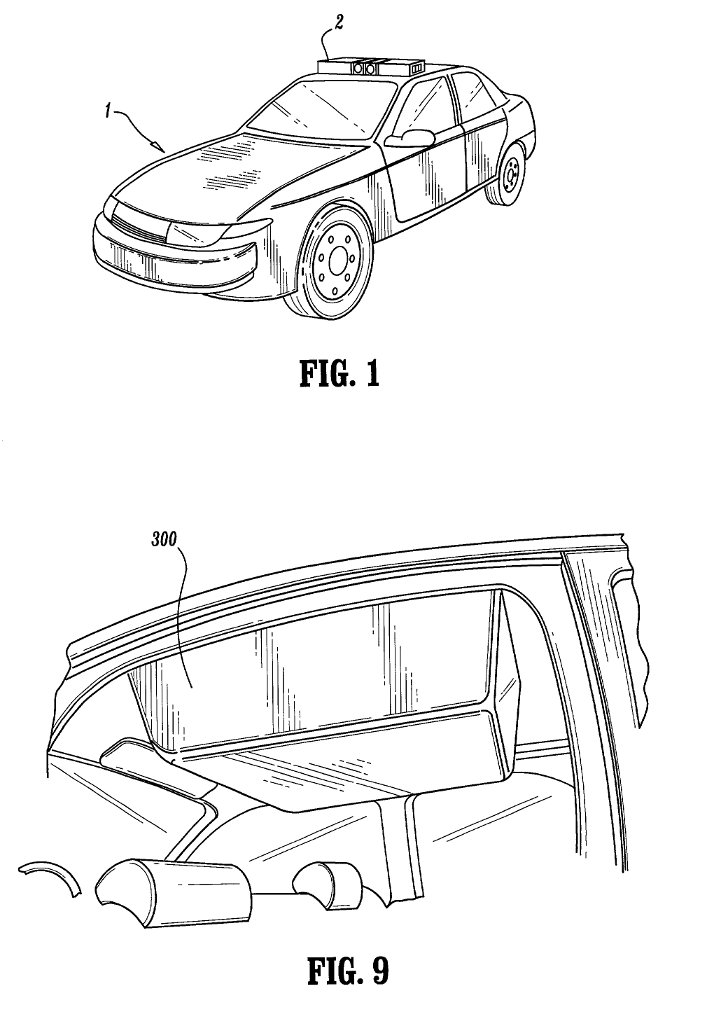

FIG. 1 depicts an emergency vehicle 1 including a retractable light bar 2 according to a preferred embodiment, extending from the roof of vehicle 1. As used herein, the term “light bar” refers to any type of system including but not limited to lighting or warning systems and may include one or more of strobe lighting, halogen lighting, various other types of lighting systems, adjustable or non-adjustable spot lights, siren systems, video camera systems, etc.

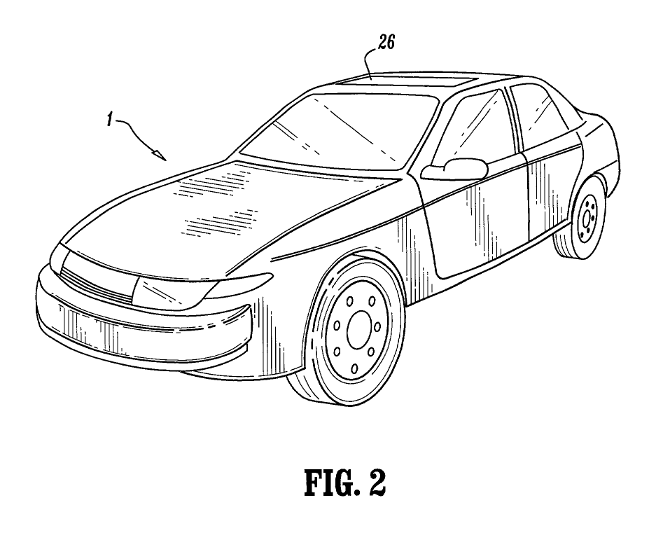

Light bar 2 is retractable between an extended position as shown in FIG. 1 and a retracted position as shown in FIG. 2. As shown in FIG. 2, when retractable light bar 2 is retracted, a roof cover portion part 26 covers the opening from which retractable light bar 2 is capable of extending.

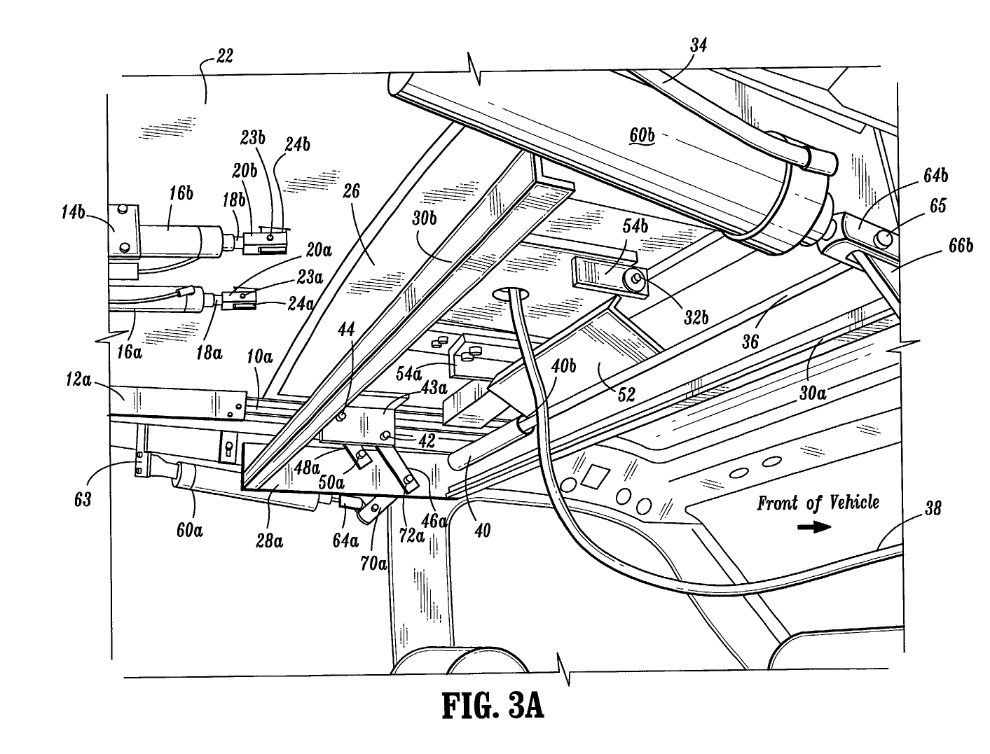

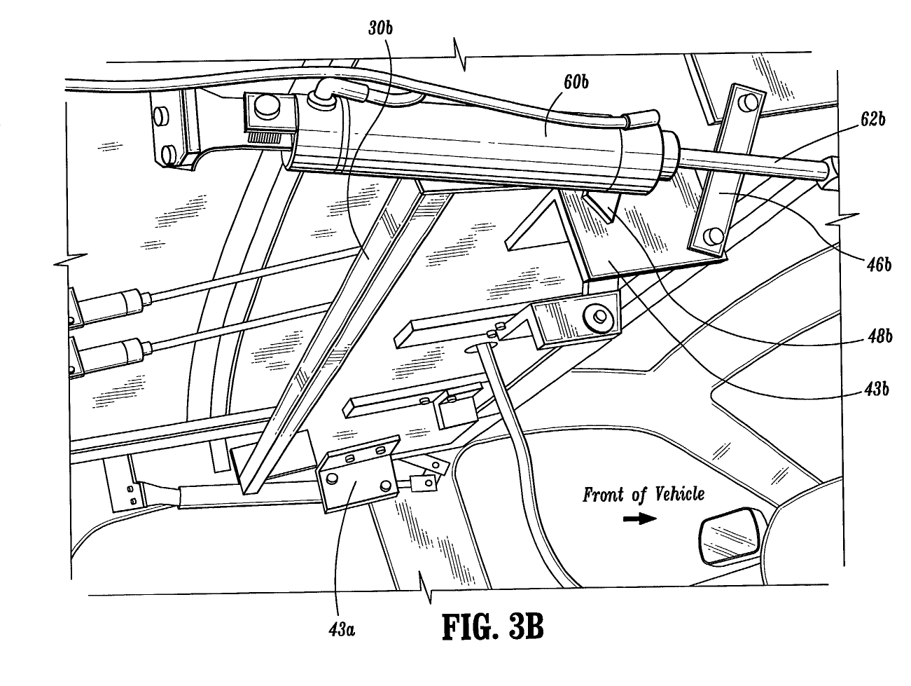

The mechanism for moving retractable light bar 2 between the extended position shown in FIG. 1 and the retracted position shown in FIG. 2 will be described by reference to FIGS. 3-6.

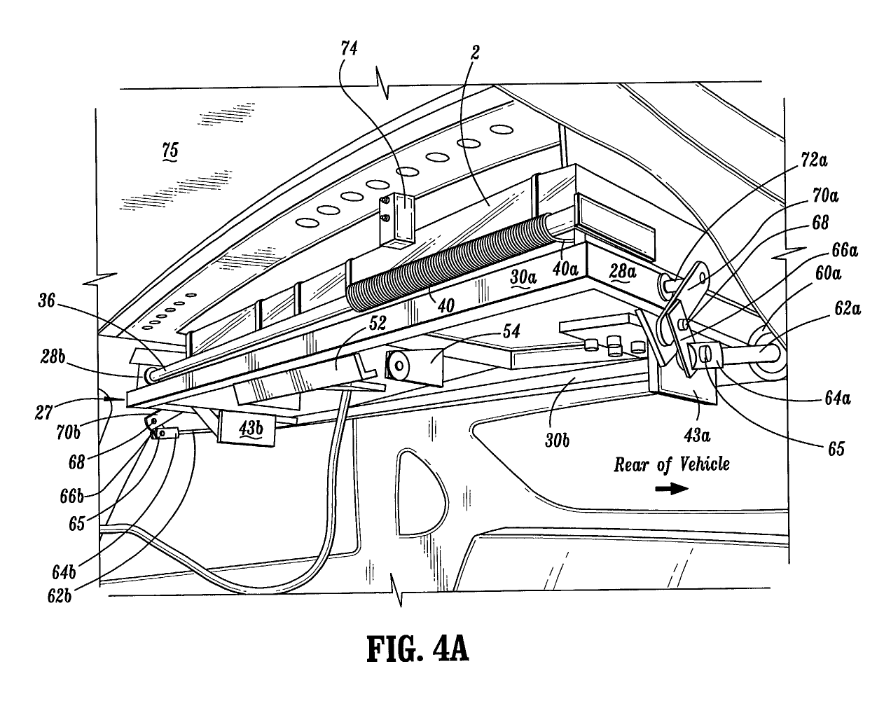

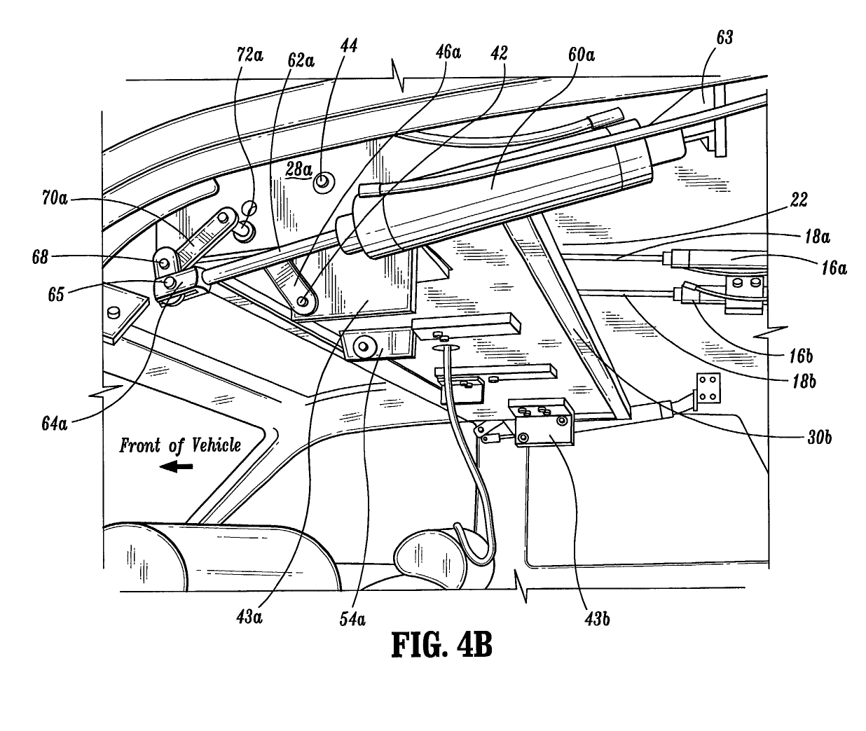

FIGS. 4A, 4B depict the inside of the vehicle with a protective cover removed for describing various elements of the light bar moving mechanism. Support frame assembly 27 includes side plates 28A and 28B and front and rear support bars 30A and 30B, respectively. Each side plate 28A, 28B extends to and is mounted to the roof 75 of the vehicle. Side plate 28A includes a pivoting hole through which a pivot pin 72A extends. Pivot pin 72A extends from both sides of side plate 28A. Side plate 28B includes a similar pivoting hole and pivot pin 72B although not shown. Each pivot pin 72A, 72B is connected to a respective swing arm 70A, 70B. The distal ends of swing arms 70A, 70B are respectively connected to connector arms 66A, 66B via nut/bolt combinations 68. Connector arms 66A, 66B are pivotally connected to respective U-shaped piston rod connectors 64A, 64B via pins 65. U-shaped piston rod connectors 64A, 64B in turn are screwed to, welded to or otherwise connected to respective piston rods 62A, 62B. The ends of piston assemblies 60 are mounted to the roof of the vehicle by brackets 63.

Referring now to FIGS. 3A, 3B, pivot pin 72A extends through side plate 28A and is mounted to swing arm 46A. The distal end of swing arm 46A includes another pivot pin 42 which extends through L-shaped support bracket 43A. Side plate 28A also includes pivot pin 50A extending therefrom on which secondary swing arm 48A is pivotally mounted. The distal end of secondary swing arm 48A is pivotally connected to L-shaped support bracket 43A via pivot pin 44. A similar mechanism is provided for connecting to L-shaped support bracket 43B and will therefor not be described in additional detail.

The mechanism includes a biasing system for biasing the light assembly in an upward direction. The biasing system includes a biasing plate swivel rod 36 rotatably mounted through holes in side plates 28A and 28B. Biasing plate swivel rod 36 extends through a biasing spring 40, as shown. Biasing plate 52 is screwed, welded or otherwise mounted to biasing plate swivel rod 36. End 40B of biasing spring 40 rests against the bottom of biasing plate 52 as shown in FIG. 3. As shown more clearly in FIG. 4A, end 40A of biasing spring 40 rests against front support bar 30A.

Light assembly base 26 supports light bar assembly 2 and is dimensioned to fit within the opening 35 in the roof of the vehicle. A gasket (not shown) extends around the peripheral edge of the opening in the roof providing a waterproof seal when roof cover 22 or light assembly base 26 are moved into position. L-shaped support brackets 43A and 43B are screwed, welded or otherwise connected to light assembly base 26. Biasing plate mounting brackets 54A and 54B are also screwed, welded or otherwise mounted to light assembly base 26. Biasing plate 52 is pivotally mounted to biasing plate mounting brackets 54A, 54B via biasing plate pivot pins 32A and 32B, respectively, which extend from the ends of biasing plate 52.

FIGS. 4A and 3B depict the light assembly 2 in its retracted position. As shown, in this position piston rods 62A, 62B are fully extended from the piston assemblies 60A, 60B, respectively. In this position, biasing spring 40 biases or urges bias plate 52 in an upward direction towards the roof of the vehicle. When piston rods 62A, 62B are retracted into piston assemblies 60A, 60B, respectively, swing-arms 70A, 70B are pulled towards the piston assemblies 60A, 60B which, in turn, rotates swing-arms 46A, 46B, 48A, 48B in an upward direction. The swing-arms 46A, 46B, 48A, 48B being pivotally connected to L-shaped brackets 43A, 43B, thus move light assembly base 26 in an upward direction towards the roof of the vehicle, extending light bar assembly 2 from the roof.

Electrical relay assembly 74 (FIG. 4A) is provided so that when light assembly base 26 reaches its upper position covering the opening, the motors driving piston assemblies 60A, 60B are stopped. That is, relay assembly 74 is electrically connected to the mechanism that drives piston assemblies 60A and 60B. When the light assembly base 26 reaches its upward position it engages relay assembly 74 which sends a signal to the control mechanism that drives piston assemblies 60A, 60B thereby stopping piston assemblies 60A, 60B from further movement. Relay assembly 74, includes two relay switches, a first relay switch for relaying information indicating when the light assembly has reached its uppermost position, and a second relay switch for relaying information indicating when the roof cover assembly has reached a position covering the opening within the roof.

A roof cover 22 is used to cover the opening in the roof of the vehicle when the light assembly base 26 is in its retracted position, and will be described by reference to FIGS. 3A, 3B. Roof cover 22 has screwed, welded or otherwise mounted thereto, roof cover pivot assemblies 24A, 24B as shown. In addition, on each end of the roof cover 22, roof tracks 12A, 12B are respectively mounted. Roof tracks 12A, 12B, are slidably supported within roof cover guide tracks 10A, 10B, respectively, which are mounted to the roof of the vehicle. U-shaped piston rod connectors 20A, 20B are pivotally connected to roof cover pivot assemblies 24A, 24B via pins 23A, 23B, respectively. U-shaped piston rod connectors 20A, 20B are screwed, welded or otherwise connected to the respective roof piston rods 18A, 18B. Roof pistons 16A, 16B are connected to roof piston mounting brackets 14A, 14B, respectively, which are also mounted to the roof of the vehicle. FIG. 3A shows the roof cover 22 in its retracted position which allows light assembly 2 to be risen, thus extending the light assembly 2 from the roof of the vehicle. As shown in FIG. 3B, when the light assembly base 26 is lowered to its lowest position, roof pistons 16A, 16B are driven to extend roof piston rods 18A, 18B, respectively, to move roof cover 22 in a forward direction towards the opening 35 in the roof. The roof cover 22 is guided with the aid of roof tracks 12A, 12B and roof cover guide tracks 10A, 10B, respectively. Roof pistons 16A, 16B are driven to extend roof piston rods 18A, 18B respectively, until the roof cover 22 completely covers the opening within the roof of the vehicle.

Since roof covers are provided when the light bar is in its extended and retracted positions, the enclosure holding the components can remain free from rain, snow, etc., which might otherwise effect the operation of the components.

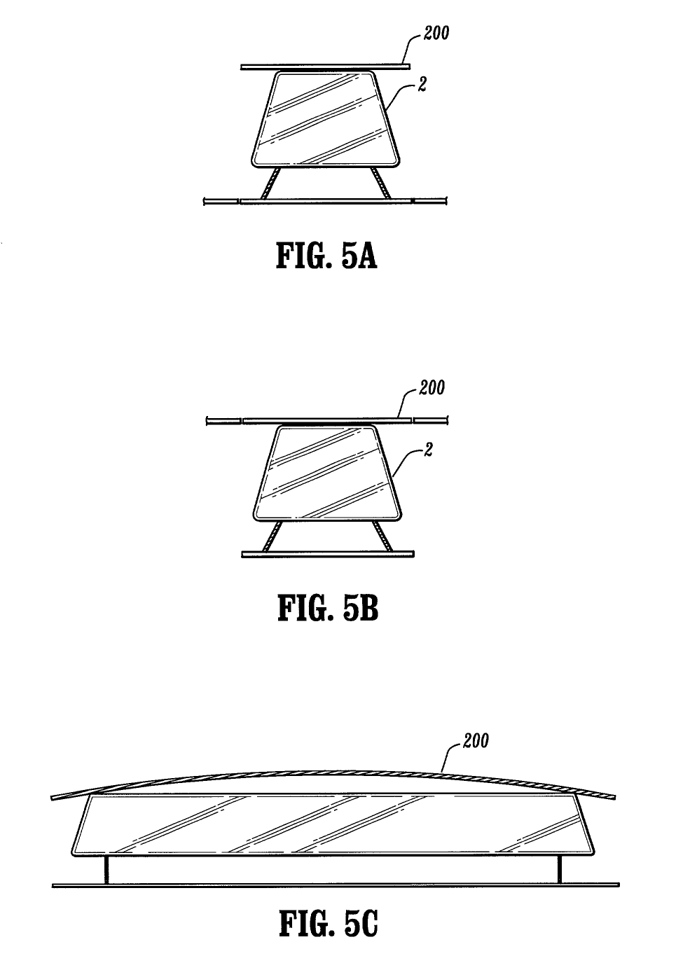

In the alternative to providing the roof cover with a separate mechanism for being moved into position as described above, a roof cover plate can be mounted to the top of the light bar as shown in FIG. 5. In this embodiment, light bar assembly 2 has a roof cover plate 200 mounted thereto. FIG. 5A depicts the light bar assembly 2 extending from the roof of the vehicle. FIG. 5B depicts the light bar assembly 2 in its retracted position. As shown in FIG. 5C, roof cover plate 200 can be curved to contour to the roof of the vehicle. Roof cover plate 200 can be integrally formed with the light bar assembly 2 or can be mounted thereto.

Each of the piston assemblies described herein can operate using any one of several known techniques. For example, the piston assemblies can be pneumatic, hydraulic, or mechanical. In the alternative, any combination of these types of piston assemblies or other types of drive mechanisms can be used. This includes screw type drive assemblies for moving one or more of the mentioned elements.

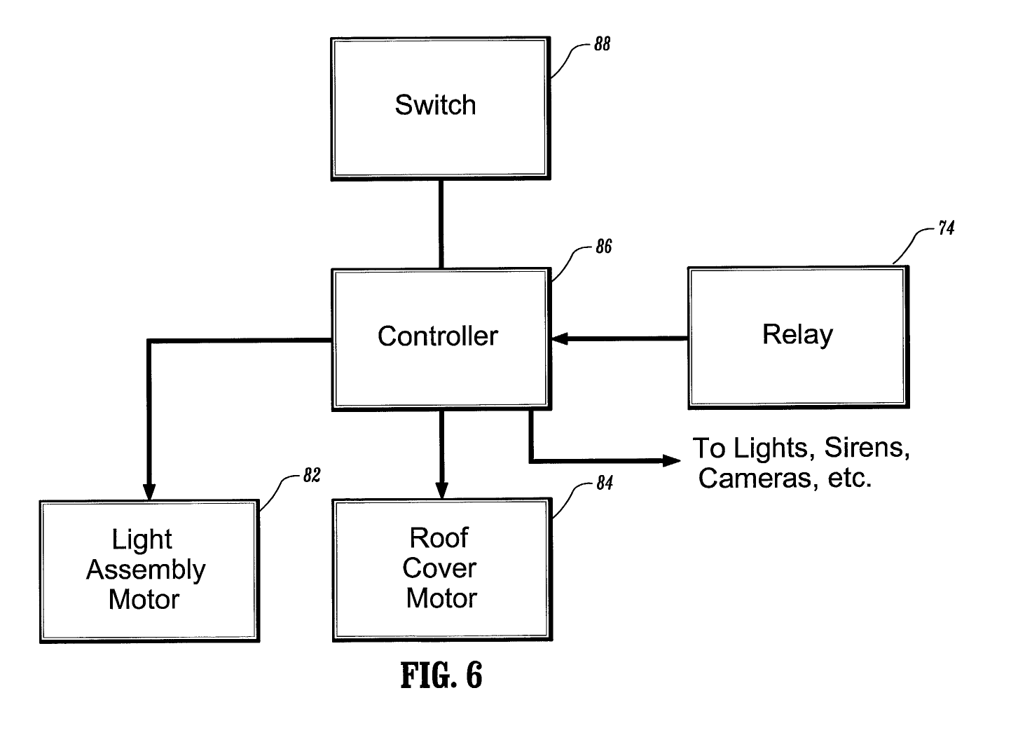

FIG. 6 depicts a control system for controlling each of the above-mentioned elements. As shown, the control system includes light assembly motor 82, roof cover motor 84, and controller 86, along with relay 74, and a user operable switch 88. The motors can be provided in the trunk of the vehicle, for example, and are connected to the pistons via hose connection, wire connection, etc., as appropriate. When user operable switch 88 is in the OFF position, controller 86 controls light assembly motor 82 to drive piston assemblies 60A, 60B thus extending piston rods 62A, 62B, respectively, therefrom thereby lowering light assembly base 26 to its lowest position. Controller 86 also controls roof cover motor 84 to drive roof pistons 16A, 16B and extending roof piston rods 18A, 18B, respectively, thereby moving roof cover 22 to its fully extended position covering the opening in roof of the vehicle. When roof cover 22 reaches the position covering the opening in the roof, it engages a relay switch in relay 74 which thereby provides a feedback signal to controller 86 which in turn stops roof cover motor 84.

When the user operable switch 88 is switched to the ON position, the process is reversed. Controller 86 controls roof cover motor 84 to retract the roof cover 22 to its fully retracted position. Controller 86 also operates light assembly motor 82 to retract piston rods 62A, 62B thereby raising light assembly base 26 to its fully extended position. In this fully extended position, the light assembly base 26 engages a relay switch in relay assembly 74 which provides a feedback to controller 86 which in turn stops the light assembly motor 82.

The sealing cover 300 shown in FIG. 9 completely encloses the moving mechanisms. Although not shown in FIG. 9, the sealing cover 300 includes a drain system for draining water that may enter through the opening in the roof of the vehicle.

Of course, various other types of controlling mechanisms for controlling each of the motor assemblies are possible. In addition, using proper valving techniques, one motor assembly could be used for driving the pistons used for moving each of the roof cover 22 and the light assembly base 26. Controller 86 can also be connected to the lights within the light assembly 2 so that when light assembly 82 is in its extended position as shown in FIG. 1, the lights are automatically activated or are activated while the light assembly is in the process of moving to its extended position.

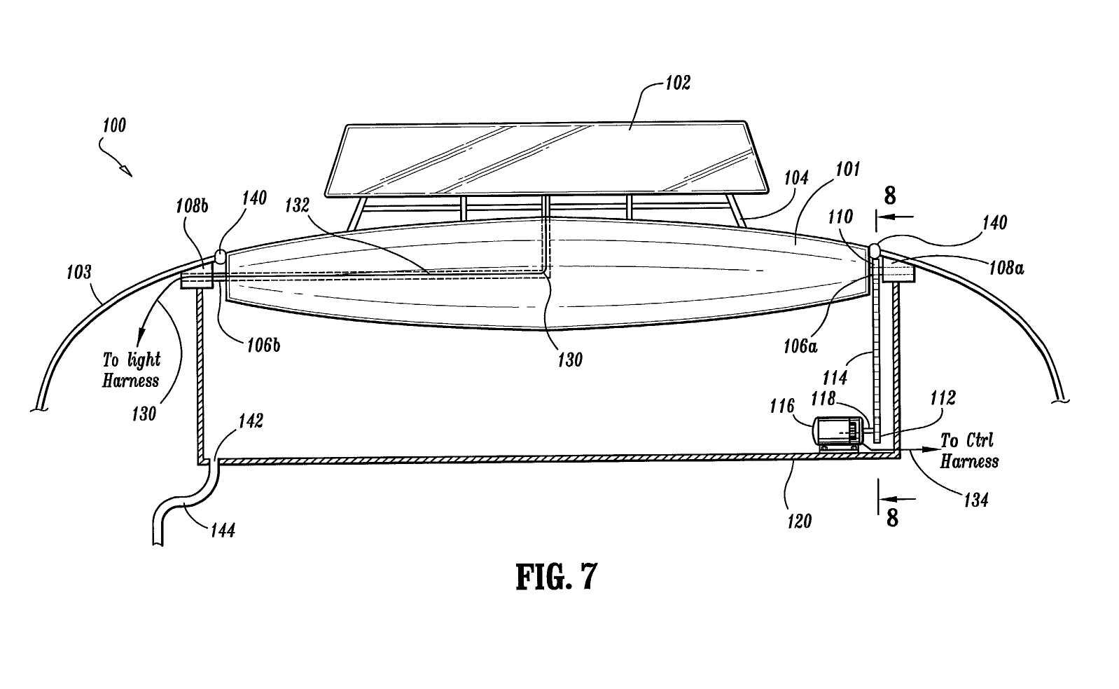

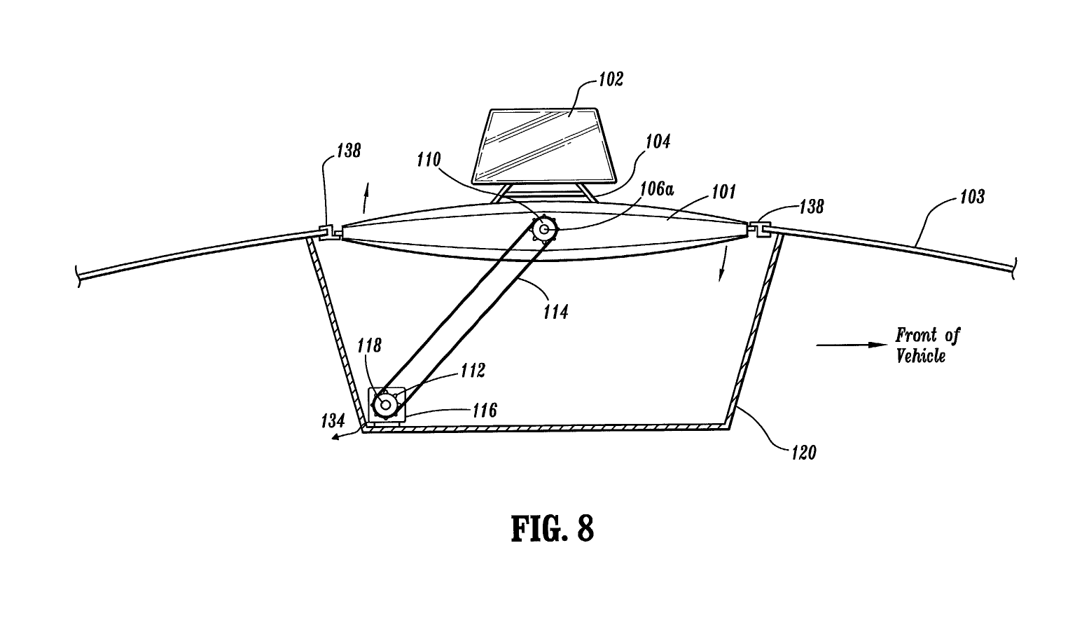

Various type of retractable light bar assemblies are also contemplated in the present disclosure. For example, the retractable light assembly can be mounted on a rotatable base as will be described below by reference to FIGS. 7 and 8.

In this embodiment, a sealed light storage chamber 120 is provided on the roof 103 of the vehicle 100. A light bar assembly 102 is mounted to light/roof plate 101 via roof mounts 104. Pivot pins 106A, 106B extend from each end of plate 101 as shown, providing a pivot point about which plate 101 can rotate. Pivot mounts 108A, 108B are mounted to roof 103 of the vehicle such that their ends are substantially at the edge of the opening in the roof 103. Pivot pins 106A, 106B are pivotally supported by pivot mounts 108A, 108B, respectively. Pivot pin 106B is hollow. Light/roof plate 101 can be hollow or can be solid with a channel 132 extending therethrough. Wires 130 for light bar 102 extend through channel 132 and hollow pivot pin 106B and to a wiring harness (not shown).

Pivot pin 106A has a sprocket 110 mounted thereto. A motor 116 is mounted to the inside of light storage chamber 120 and includes a shaft 118 with a sprocket 112 mounted thereto. A chain or belt 114 extends between sprockets 110 and 112. Wires 134 for operating motor 116 extend through a sealed opening formed in light storage chamber 120 to a control wiring harness (not shown).

A seal 138 is provided along the front and rear edges thereof for sealing the front and rear edges from the elements, as shown in FIG. 8. A pliant foam or other sealing material 140 is provided along the side edges for sealing the side edges from the elements as shown in FIG. 7. A drain hole 142 is provided along a lower edge of light storage chamber 120 and is connected to a drain tube 144 which runs down along an enclosed inside wall of the vehicle to a lower portion of the vehicle where water can drain out. The bottom of light storage chamber 120 preferably is slightly tapered from all directions toward drain hole 142 so that any water which may enter light storage chamber 120 can be quickly drained out of the chamber.

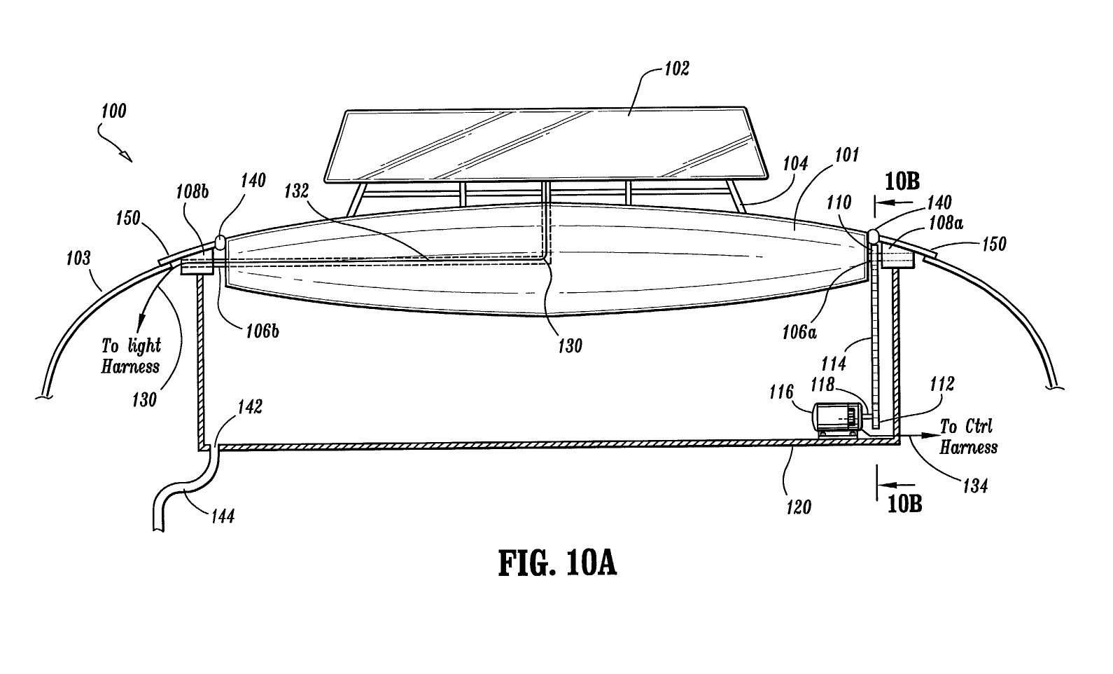

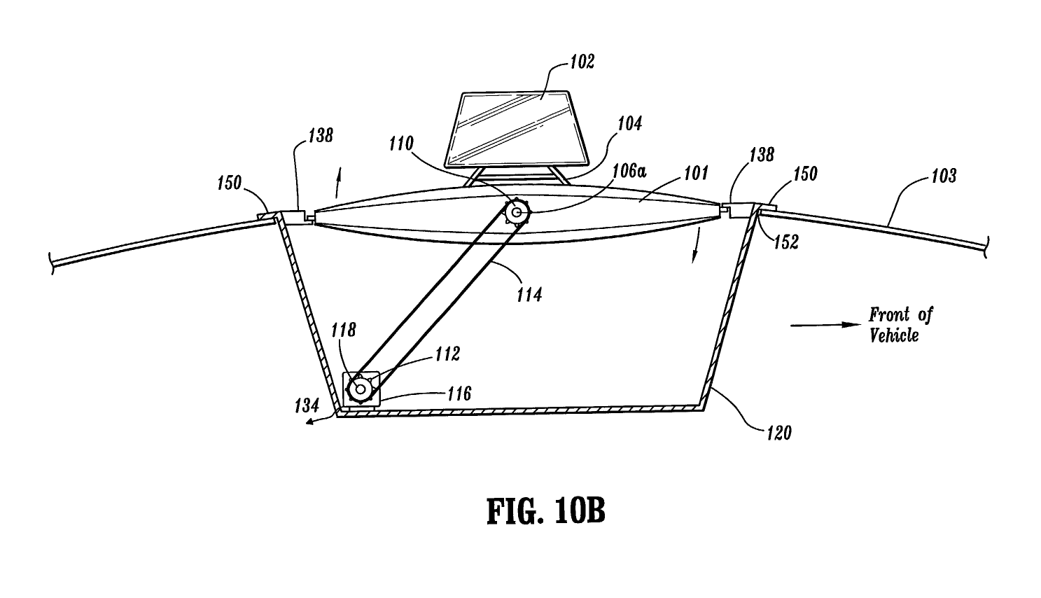

Either of the above embodiments can be made as a unit, allowing easy installation of the retractable light assembly into a vehicle. For example, as shown in FIGS. 10A, 10B, light storage chamber 120 includes a peripheral lip 150 which extends around the entirely thereof. When the unit is to be mounted, a properly dimensioned hole 152 is cut in roof 103 and the light unit is placed in the opening. A foam insulation or silicon (not shown) can be used to seal between the edge of the roof 103 and the lip 150. The light unit can be held in place by spot weld, brackets, screws, etc. Of course, roofs of vehicles may not always be flat. Accordingly, it may be desirable for the lip 150 to be designed to follow the contour of the roof, thus providing a neat and attractive seal along the roof.

Numerous additional modifications and variations of the present embodiments are possible in view of the above-teachings.

What is claimed is:

1. A light bar assembly retractably mounted within a roof of a vehicle for extending from an opening in the roof of the vehicle, comprising:
a roof cover assembly, moveable between a first position and a second position covering the opening in the roof of the vehicle;
a light bar assembly moveable between a first position and a second position extending from the opening in the roof of the vehicle; and
a control mechanism for selectively controlling the roof assembly and the retractable light bar assembly between their respective first and second positions.

2. A light bar assembly as recited in claim 1, wherein the control mechanism comprises pistons for moving the roof assembly and retractable light bar assembly between their respective first and second positions.

3. A light bar assembly as recited in claim 2, wherein the pistons comprise at least one of pneumatic, hydraulic and mechanical pistons.

4. A light bar assembly as recited in claim 1, further comprising a biasing system for biasing the light bar assembly toward an extended position.

5. A light bar assembly as recited in claim 4, wherein the biasing system comprises a spring assembly.

6. A light bar assembly as recited in claim 1, wherein the light bar assembly comprises a light assembly base for sealing the opening in the room of the vehicle when the light bar assembly is in at least one of the first and second positions.

7. A light bar assembly retractably mounted within a roof of a vehicle for extending from an opening in the roof of the vehicle, comprising:
a light bar assembly moveable between a first position and a second position extending from the opening in the roof of the vehicle;
a roof cover, mounted to a portion of the light bar assembly, for sealing the opening in the roof when the light bar assembly is in at least one of the first and second positions; and
a control mechanism for selectively controlling the roof assembly and the retractable light bar assembly between their respective first and second positions.

8. A light bar assembly mounted within a roof of a vehicle for extending from an opening in the roof of the vehicle, comprising:
a rotatable roof assembly, pivotally mounted in the opening in the roof of the vehicle;
a light bar assembly, mounted to at least one surface of the rotatable roof assembly; and
a control mechanism for selectively rotating the rotatable roof assembly between a first position in which the light bar assembly is visible on the roof of the vehicle and a second position, in which the light bar assembly is not visible on the roof of the vehicle.

9. A light bar assembly as recited in claim 8, further comprising a gasket assembly provided around at least a portion of a periphery of the opening in the roof of the vehicle, wherein the rotatable roof assembly forms a sealed enclosure with the gasket assembly, when the rotatable roof assembly is in the first and second positions.
